(19) United States
(12) Patent Application Publication
(10) Pub. No.: US 2025/0203000 A1
(43) Pub. Date: Jun. 19, 2025

(54) NFC-BASED INTELLIGENT INK SCREEN MOBILE PHONE CASE

(71) Applicant: Shenzhen Wiwood Technology Co., Ltd., Shenzhen (CN)

(72) Inventor: Xiaofeng LI, Shenzhen (CN)

(73) Assignee: Shenzhen Wiwood Technology Co., Ltd., Shenzhen (CN)

(21) Appl. No.: 18/985,026

(22) Filed: Dec. 18, 2024

(30) Foreign Application Priority Data
Dec. 19, 2023 (CN) 202323467722.1
Sep. 13, 2024 (CN) 202422244816.0
Oct. 23, 2024 (CN) 202422566392.X

(51) Int. Cl. H04M 1/02; H04B 5/43

(52) U.S. Cl. CPC H04M 1/0203; H04B 5/43

(57) ABSTRACT

An NFC-based intelligent ink screen mobile phone case includes a protective shell, an NFC antenna and an ink screen; an accommodating groove for accommodating a mobile phone is formed in the protective shell; a connecting component is arranged between the ink screen and the NFC antenna and used for electrically connecting the NFC antenna to the ink screen or separating the NFC antenna from the ink screen. The connecting component realizes separation of the NFC antenna from the ink screen on the protective shell, different NFC antennas can be combined with the ink screen through the same connecting component, NFC antennas of different shapes and parameters fit the ink screen through unified connecting components. The design greatly improves compatibility with mobile phones of different models and sizes, reduces change in molds and production processes for different mobile phone designs, and reduces the cost of production and adaptation.

### FIELD OF THE INVENTION

The present invention relates to the technical field of mobile phone cases, and particularly relates to an NFC-based intelligent ink screen mobile phone case.

### BACKGROUND OF THE INVENTION

Mobile phone case is an ornament that protects or decorates the appearance of a mobile phone, and an e-ink screen is a novel method and technology that innovates the information display. Like most traditional inks, e-ink and lines that change its color can be printed to many surfaces, such as bent plastic, polyester films, paper to cloth; and it is different from traditional paper in that the e-ink changes its color when power is applied, and may also display a changing image like a traditional screen.

A separate power supply way is usually adopted in an existing ink screen mobile phone case, and it is needed to charge after using for a period of time, so it has a certain non-deformation when in use; moreover, a charging structure of the mobile phone case may increase the thickness and weight of the mobile phone case; and the main purpose of the mobile phone case is to protect the mobile phone, but the increase of thickness and weight brings inconvenience in carrying and use and also affects the aesthetics.

### SUMMARY OF THE INVENTION

An objective of the present disclosure is to provide an NFC-based intelligent ink screen mobile phone case to solve the defects and deficiencies in related technology. The NFC-based intelligent ink screen mobile phone case has the advantages that the weight and thickness of a protective shell are reduced, and the separation of an NFC antenna from an ink screen on the protective shell is realized through a connecting component, so that different NFC antennas can be combined with the ink screen through the same connecting component, and the NFC-based ink screen mobile phone case can be compatible with mobile phones of different models.

In order to achieve the above objective, the present invention adopts the following technical solutions:
an NFC-based intelligent ink screen mobile phone case includes a protective shell, and an accommodating groove for accommodating a mobile phone is formed in the protective shell; the NFC-based intelligent ink screen mobile phone case further includes an NFC antenna and an ink screen which are arranged on a back surface of the protective shell;
a connecting component is arranged between the ink screen and the NFC antenna; and the connecting component is used for electrically connecting the NFC antenna to the ink screen or separating the NFC antenna from the ink screen.

Optionally, the NFC-based intelligent ink screen mobile phone case further includes an installation plate arranged on the back surface of the protective shell; an installation groove for installing the NFC antenna and the ink screen is formed in a top portion of the installation plate; an edge of the NFC antenna is tightly adjacent to an edge of the protective shell to increase a projection overlapping area of the NFC antenna and an NFC antenna of the mobile phone.

Optionally, an upper edge of the installation groove extends towards an upper end frame of the protective shell until the height of an upper edge of the installation groove is above an inner wall of an upper end of the protective shell, so as to increase the projection overlapping area of the NFC antenna and the NFC antenna of the mobile phone.

Optionally, a spacing between an edge, close to a side wall of the protective shell, of the installation groove and the edge of the protective shell is less than 5 mm so that the projection overlapping area of the NFC antenna and the NFC antenna of the mobile phone is increased.

Optionally, the NFC-based intelligent ink screen mobile phone case further includes an NFC cover sheet, and the NFC cover sheet covers the NFC antenna; and when the NFC cover sheet covers the NFC antenna, the NFC cover sheet is flush with an upper surface of the installation plate.

Optionally, the cross section of at least one of an upper end and a lower end of the protective shell is greater than the cross sections of a left side and a right side of the protective shell.

Optionally, anti-fall bumps are arranged at top covers of the protective shell.

Optionally, a buffer member is arranged in the installation groove.

Optionally, damping bumps are arranged at the edges of the protective shell.

Optionally, a lens frame is arranged on the back surface of the protective shell; the lens frame is hinged with a bracket; and

when the protective shell is horizontally placed, the bracket is unfolded to support the mobile phone case.

Compared with the prior art, the present invention has the following beneficial effects: the NFC-based intelligent ink screen mobile phone case includes the protective shell, the NFC antenna and the ink screen which are arranged on the back surface of the protective shell; the accommodating groove for accommodating the mobile phone is formed in the protective shell; the connecting component is arranged between the ink screen and the NFC antenna, and the connecting component is used for electrically connecting the NFC antenna to the ink screen or separating the NFC antenna from the ink screen; the ink screen is wirelessly connected to the NFC antenna built in the mobile phone through the NFC antenna in the protective shell, so that the ink screen takes power from the mobile phone through the NFC antenna, an internal power supply does not need to be integrated in the electronic ink screen, and then the weight and the thickness of the protective shell are reduced; moreover, the NFC antenna in the protective shell is connected to the NFC antenna built in the mobile phone in a wireless matching manner, thus data transmitted by a mobile phone device can be displayed through the ink screen; the connecting component is arranged, thus the separation of the NFC antenna from the ink screen on the protective shell can be realized, different NFC antennas can be combined with the ink screen through the same connecting component, and NFC antennas of different shapes and parameters can be adapted to the ink screen through unified connecting components; and through such design, the compatibility with mobile phones of different models and sizes can be greatly improved, the change in molds and production processes for different mobile phone designs is reduced, and then the effect of reducing the cost of production and adaptation is achieved.

### BRIEF DESCRIPTION OF THE DRAWINGS

In order to more clearly illustrate the embodiments of the present invention or the technical solutions in the related technology, the accompanying drawings that need to be used in the embodiments or related technology descriptions will be briefly introduced below; definitely, the accompanying drawings in the following description are only some embodiments of the present invention; and for those of ordinary skill in the art, other accompanying drawings can also be obtained according to these accompanying drawings without the premise of creative labor.

The structure, proportion, size, etc. shown in the accompanying drawings of this specification are only used for cooperating with the contents revealed in the description for the understanding and reading of persons familiar with the art, and are not used for limiting the limitations that can be implemented by the present invention, so they have no technical substantive significance, and any modification of the structure, change of a proportional relationship or adjustment of the size, without affecting the efficacy that the present invention can produce and the purpose that can be achieved, shall still fall within the scope that the technical content revealed in the present invention can be covered.

FIG. 1 is a structural schematic diagram of an NFC-based intelligent ink screen mobile phone case;

FIG. 2 is a structural schematic diagram of an NFC-based intelligent ink screen mobile phone case in another direction;

FIG. 3 is a schematic diagram of an unfolding state of a glass cover sheet of an NFC-based intelligent ink screen mobile phone case;

FIG. 4 is a schematic diagram of a folding state of a mylar of an NFC-based intelligent ink screen mobile phone case;

FIG. 5 is an exploded schematic diagram of an NFC-based intelligent ink screen mobile phone case;

FIG. 6 is another exploded schematic diagram of an NFC-based intelligent ink screen mobile phone case;

FIG. 7 is a section view of an NFC-based intelligent ink screen mobile phone case;

FIG. 8 is a structural schematic diagram of another embodiment of an NFC-based intelligent ink screen mobile phone case;

FIG. 9 is a rear view of another embodiment of an NFC-based intelligent ink screen mobile phone case;

FIG. 10 is an overall structural schematic diagram of another embodiment of an NFC-based intelligent ink screen mobile phone case;

FIG. 11 is a structural exploded schematic diagram of another embodiment of an NFC-based intelligent ink screen mobile phone case;

FIG. 12 is a structural schematic diagram of components of a hidden part of another embodiment of an NFC-based intelligent ink screen mobile phone case;

FIG. 13 is an enlarged diagram of a connecting component of an NFC-based intelligent ink screen mobile phone case;

FIG. 14 is a structural exploded schematic diagram of an Embodiment 2 of an NFC-based intelligent ink screen mobile phone case;

FIG. 15 is a part structural schematic diagram of an Embodiment 2 of an NFC-based intelligent ink screen mobile phone case;

FIG. 16 is a schematic diagram of a protective shell in an Embodiment 2 of an NFC-based intelligent ink screen mobile phone case; and

FIG. 17 is a part structural rear view of an Embodiment 2 of an NFC-based intelligent ink screen mobile phone case.

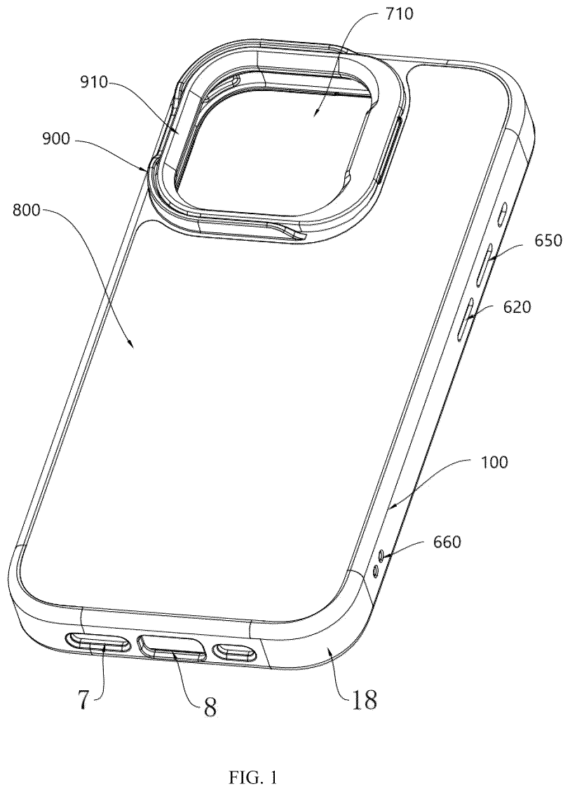

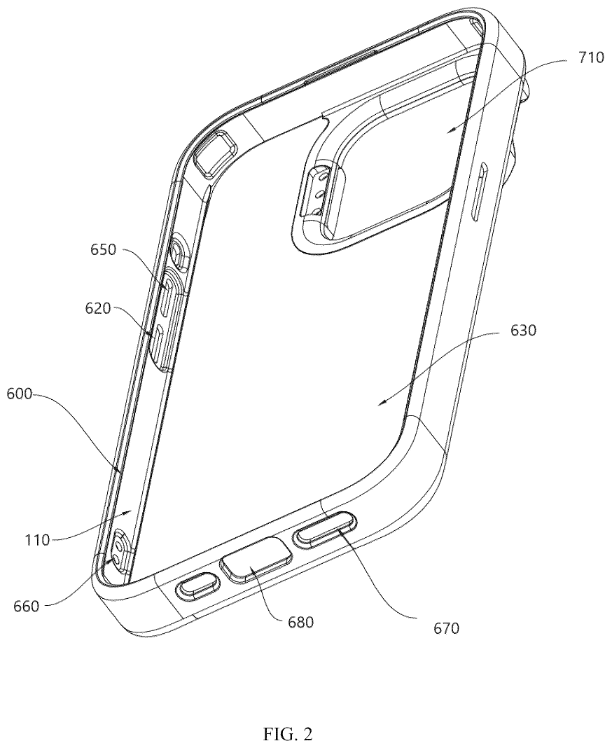

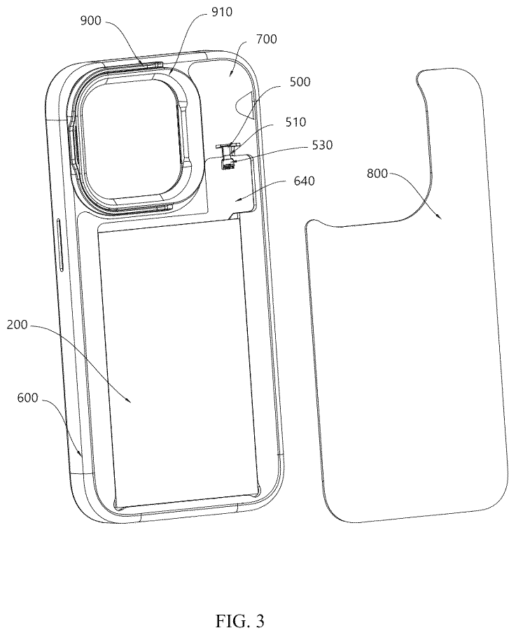

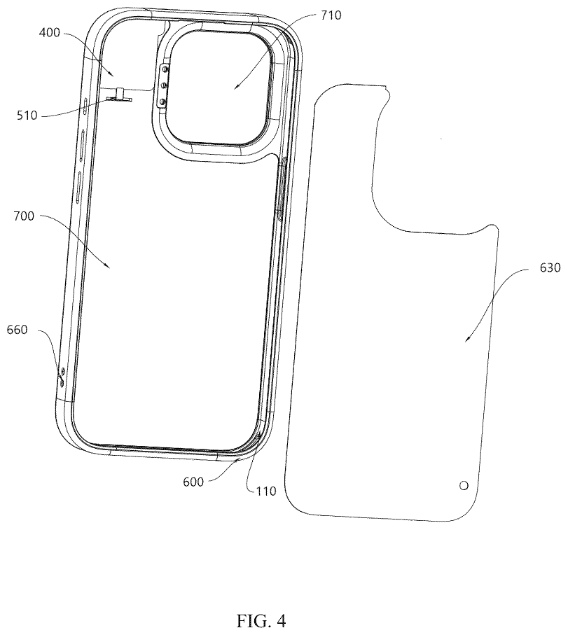

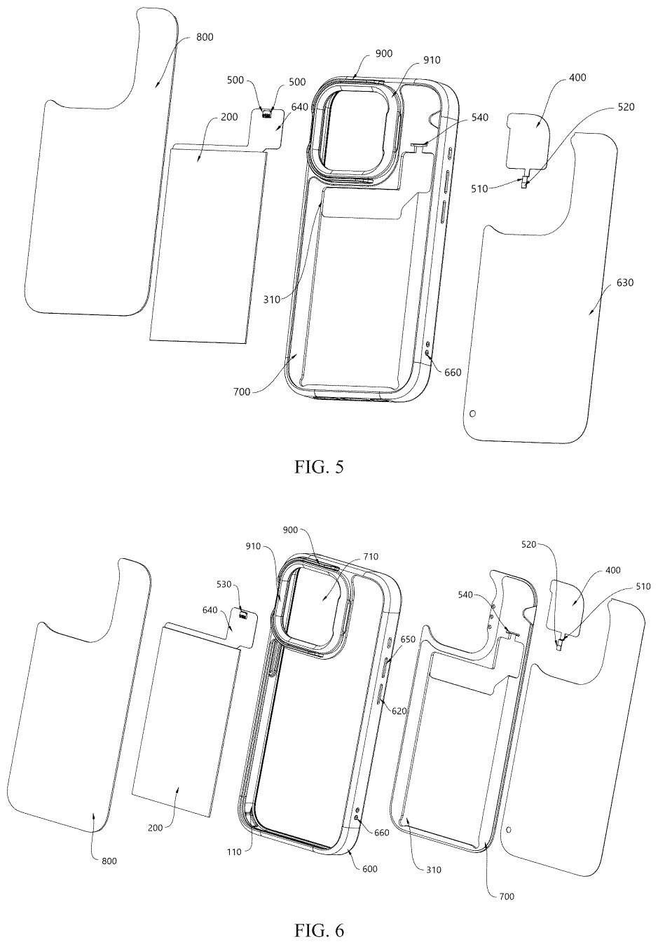

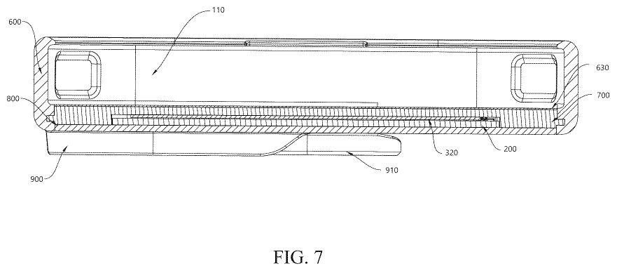

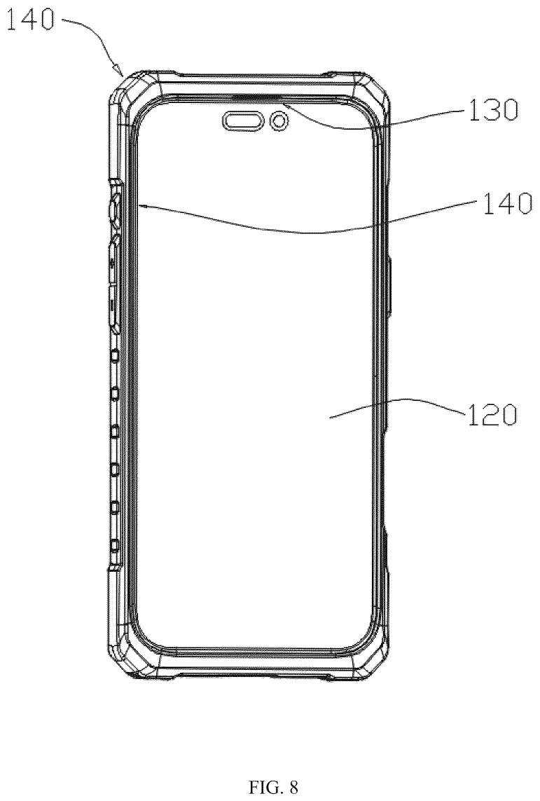

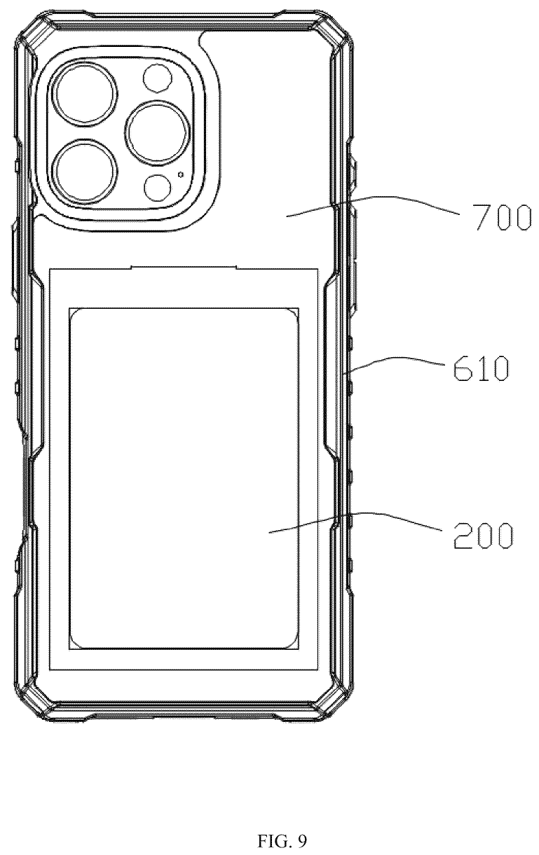

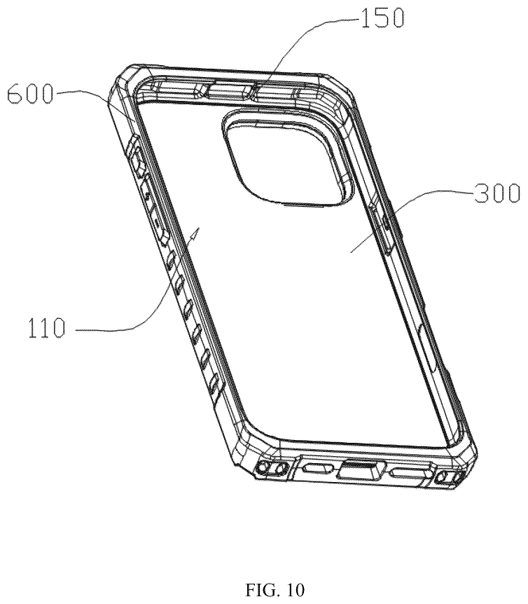

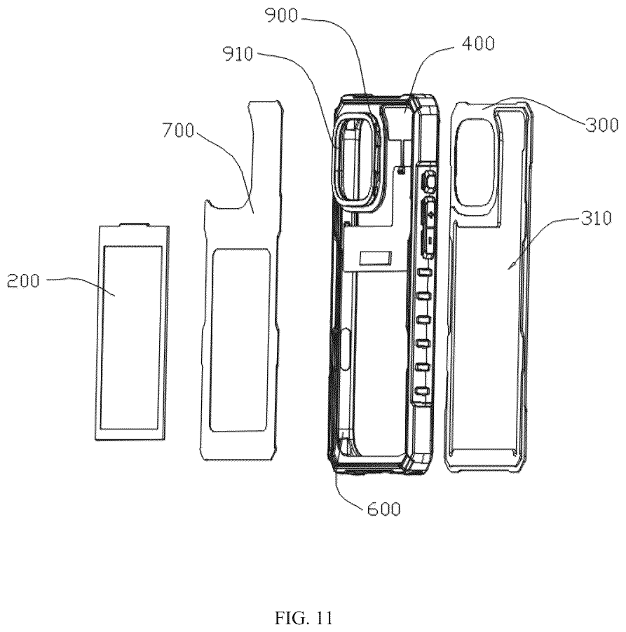

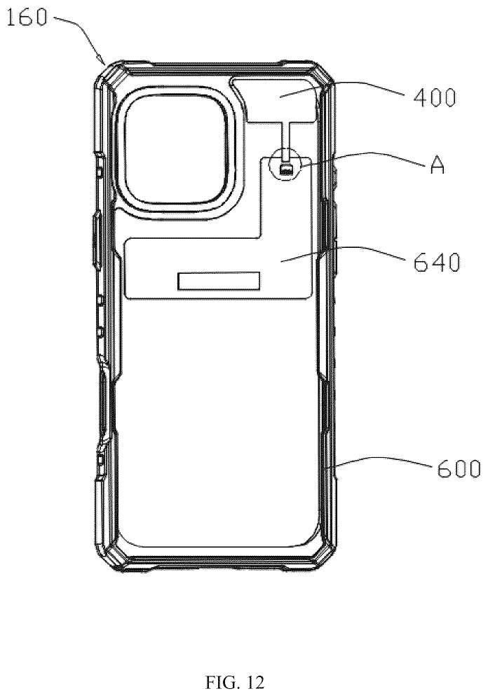

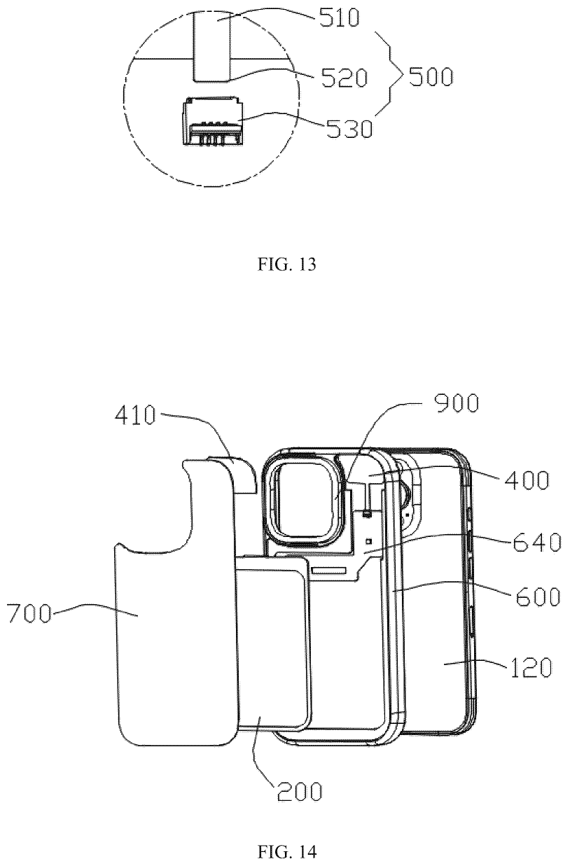

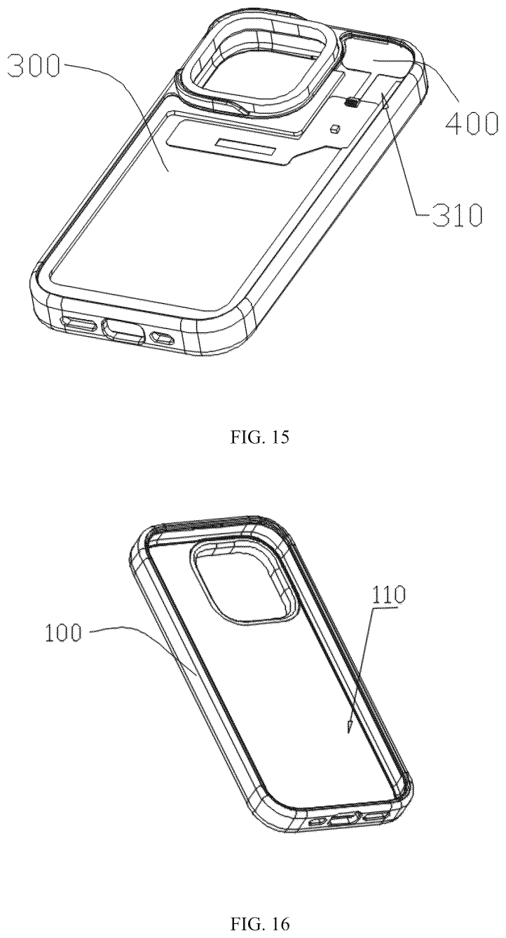

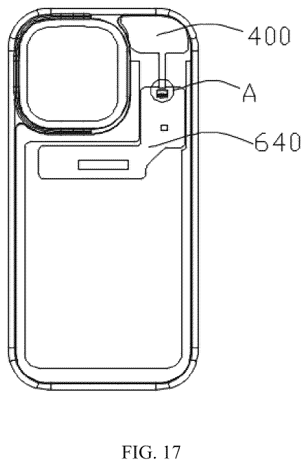

### DESCRIPTION OF REFERENCE NUMERALS

100, protective shell; 110, accommodating groove; 120, mobile phone; 130, first buffer part; 140, second buffer part; 150, rib; 160, convex edge;
200, ink screen;
300, installation plate; 310, installation groove; 320, buffer member;
400, NFC antenna; 410, NFC cover sheet;
500, connecting component; 510, flat cable; 520, connecting terminal; 530, connector; 540, penetrating hole;
600, frame body; 610, limiting edge; 620, on-off key; 630, mylar; 640, control circuit board; 650, volume key hole; 660, rope hole; 670, loudspeaker hole; 680, charging hole;
700, back plate; 710, camera hole;
800, glass cover sheet;
900, lens frame; and 910, bracket;

### DETAILED DESCRIPTION OF SOME EMBODIMENTS

In order to make the objective, features and advantages of the present invention more obvious and easy to understand, the technical solutions in the embodiments of the present invention will be clearly and completely described below in conjunction with the accompanying drawings in the embodiments of the present invention. Definitely, the embodiments described below are only some embodiments of the present invention, not all embodiments. Based on the embodiments in the present invention, all other embodiments obtained by those of ordinary in the art without making creative work belong to the scope of protection of the present invention.

In the description of the present invention, it is to be understood that the terms “upper”, “lower”, “top”, “bottom”, “inner”, “outer”, etc., indicate the orientation or positional relationship based on the orientation or positional relationship shown in the accompanying drawings, and are only for the convenience of describing the present invention and simplify the description, and do not indicate or imply that apparatuses or elements referred to must have a specific orientation, be constructed and operated in a specific orientation, and therefore cannot be construed as a limitation on the present invention. It is to be noted that when a component is considered to be “connected” to another component, it may be directly connected to another component or there may be a component arranged between them.

The technical solution of the present invention is further illustrated below in conjunction with the accompanying drawings 1-18 and through specific embodiments.

An NFC-based intelligent ink screen 200 mobile phone 120 shell includes a protective shell 100, and an accommodating groove 110 for accommodating a mobile phone 120 is formed in the protective shell 100; the NFC-based intelligent ink screen mobile phone case further includes an NFC antenna 400 and an ink screen 200 which are arranged on a back surface of the protective shell 100;

a connecting component 500 is arranged between the ink screen 200 and the NFC antenna 400; and the connecting component 500 is used for electrically connecting the NFC antenna 400 to the ink screen 200 or separating the NFC antenna 400 from the ink screen 200.

The protective shell 100 includes a frame body 600 and a back plate 700, and the accommodating groove 110 is formed by the frame body 600 and the back plate 700 in an enclosing manner; in the embodiment, the operation of the ink screen 200 in the protective shell 100 does not need any external connecting line or tail plug, and when in use, a main control program is driven through an NFC coil coupling technology to implement data transmission, the transmission content will be clearly displayed, a built-in battery or Bluetooth connection is not needed, pictures on the protective shell 100 can be replaced at any time, and thus wireless transmission is truly realized; when the ink screen 200 works, the ink screen 200 is wirelessly connected to an NFC antenna 400 built in the mobile phone 120 through the NFC antenna 400 in the protective shell 100, the ink screen 200 takes power from the mobile phone 120 through the NFC antenna 400, and therefore an internal power supply does not need to be integrated in the electronic ink screen 200, and the protective shell 100 absorbs trace power from the mobile phone 120 through NFC only when transmitting a new picture; after transmission is completed, the ink screen 200 can display the picture without power; ink capsule molecules are pushed to different positions through the control of positive and negative charges, and when current stops, the ink capsule molecules will be fixed at the current position, so that picture display does not need power; the requirement on power in the mobile phone 120 is very low and can be ignored; through such design, the weight and the thickness of the protective shell 100 can be reduced, moreover, the NFC antenna 400 in the protective shell 100 is connected to the NFC antenna 400 built in the mobile phone 120 in the wireless matching manner, thus the data transmitted by the mobile phone 120 device can be displayed through the ink screen 200. The connecting component 500 is arranged, thus the separation of the NFC antenna 400 and the ink screen 200 on the protective shell 100 is realized, different NFC antennas 400 can be combined with the ink screen 200 through the same connecting component 500, and NFC ink screen 200 mobile phone 120 case can be compatible with mobile phones 120 of different models.

Optionally, in order to realize separation or combination of the NFC antenna 400 and the ink screen 200, the NFC antenna 400 and the ink screen 200 are electrically connected; the connecting component 500 includes: a flat cable 510, a connecting terminal 520 and a connector 530. One end of the flat cable 510 is electrically connected to the NFC antenna 400; the flat cable 510 penetrates through a penetrating hole 540; the connecting terminal 520 is arranged at one end, far away from the NFC antenna 400, of the flat cable 510; the connector 530 is arranged on the back surface of the protective shell 100 and is electrically connected to the ink screen 200; the connector 530 can be inserted into or separated from the connecting terminal 520 to realize electric connection between the NFC antenna 400 and the ink screen 200 or cut off of electric connection between the NFC antenna 400 and the ink screen 200; and in one embodiment, the ink screen 200 includes an e-paper ink screen 200 and a control circuit board 640 electrically connected to the e-paper ink screen 200, and the connector 530 is attached to or welded to the control circuit board 640 and is electrically connected to the control circuit board 640.

In one embodiment, the frame body 600 and the back plate 700 are integrally formed, the frame body 600 is made of TPU+TPE materials, and the frame body 600 is rectangular; therefore, when the mobile phone 120 falls off, the TPE can effectively absorb and disperse impact force, and then the impact on all parts of the mobile phone 120, especially a fragile screen and internal elements, is reduced; compared with other rigid materials, due to the flexibility of the TPE, the damage risk can be reduced to the maximum extent when the mobile phone 120 falls off, and a protection effect is achieved; the TPU material not only has a good anti-collision performance, but also has excellent hand-feeling and anti-skid performances; and the designed material of the frame body 600 used as the protective shell 100 not only enhances the comfort when the mobile phone 120 is held, but also can effectively reduce the possibility that the mobile phone 120 slides off from the hand; compared with metal or other hard materials, the TPU and TPE materials are light, and the frame body 600 is made of the materials, so the weight of the protective shell 100 cannot be remarkably increased, the portability of the mobile phone 120 shell can be kept, and the requirements of modern users on light, thin and portable devices are met; the back plate 700 is made of a tempered glass material, and the tempered glass used as the material of the back plate 700 has extremely high transparency and excellent wear resistance, and a clear visual effect can be provided; and moreover, the hardness of the tempered glass is high, so that scraping and abrasion in daily use can be effectively resisted, and the ink screen 200 is protected from being damaged. In addition, a camera part is integrally formed at an upper end of the frame body 600, and the camera part extends from the frame body 600 to a direction far away from the installation plate 300.

In another embodiment, in the aspect of shell design, the back plate 700 of the ink screen 200 and the frame body 600 of the mobile phone 120 are subjected to a separated design; the frame body 600 and the back plate 700 are detachably connected; the accommodating groove 110 is formed by the frame body 600 and the back plate 700 in an enclosing manner; a limiting edge 610 is arranged on a side wall of the frame body 600; the limiting edge 610 and the inner side wall of the frame body 600 form a clamping groove, and the edge of the back plate 700 is clamped into the clamping groove; according to the design of the embodiment, the user can randomly replace a pattern on the ink screen 200 and can replace a frame of the protective shell 100 according to personal preference; the frame body 600 is made of a PC material; the back plate 700 is made of the tempered glass material; the PC material is a firmer and more durable material, has good impact resistance, can better protect the mobile phone in daily use, does not become yellow after long-time use, is fine and smooth in hand feeling, and is round and full in corners to better protect the mobile phone; the tempered glass used as the material of the back plate 700 has extremely high transparency and excellent wear resistance, can provide a clear visual effect, is high in hardness, can effectively resist scraping and wear in daily use, and protects the ink screen 200 from being damaged; and the frame body 600 made of the PC material and the back plate 700 made of the tempered glass are combined together through a detachable design to form a strong, firm and durable structure.

Correspondingly, the ink screen 200 mobile phone 120 shell further includes an installation plate 300 arranged on the back surface of the protective shell 100; an installation groove 310 for installing the NFC antenna 400 and the ink screen 200 is formed in a top portion of the installation plate 300; the edge of the NFC antenna 400 is tightly adjacent to the edge of the protective shell 100 to increase the projection overlapping area of the NFC antenna 400 and the NFC antenna 400 of the mobile phone 120, so that the available installation area of the NFC antenna 400 is expanded to the maximum extent; and under the condition that the area of the protective shell 100 is not increased, the back plate 700 of the protective shell 100 can accommodate and mount the NFC antenna 400 with a larger area, so that the NFC signal transmission performance of a device is improved.

In an Embodiment 1 based on the above embodiments, an upper edge of the installation groove 310 extends towards an upper end frame of the protective shell 100 until the height of the upper edge of the installation groove 310 is above the inner wall of an upper end of the protective shell 100, so as to increase the projection overlapping area of the NFC antenna 400 and the NFC antenna 400 of the mobile phone 120; and
at least one end of the cross sections of the upper end and the lower end of the protective shell 100 is larger than the cross sections of a left side and a right side of the protective shell 100.

When the mobile phone 120 is placed in the accommodating groove 110, a first buffer part 130 and a second buffer part 140 are formed between the plane of the mobile phone 120 and upper and lower end walls and between the plane of the mobile phone 120 and left and right side walls respectively, and the spacing between the first buffer part 130 and the plane of the mobile phone 120 is larger than that between the second buffer part 140 and the plane of the mobile phone 120; the wall thickness of upper and lower ends of the protective shell 100 is designed to be larger than that of the left and right sides; on one hand, the area of the NFC antenna 400 is increased, the installation space in the protective shell 100 needs to be correspondingly increased, and it is achieved by increasing the wall thicknesses of the upper and lower ends of the protective shell 100, so that enough space of the installation groove 310 is provided for the NFC antenna 400 with a large area, and the overall size and portability of the protective shell 100 are kept; the thickened upper and lower end walls not only provide necessary space for installing the NFC antenna 400 with the large area, but also improve the signal strength and enhance the compatibility of the device, thus the signal transmission capacity is higher, and interaction with NFC devices of various sizes and shapes can be achieved; and on the other hand, such design enhances the structural strength of the protective shell 100, and provides better anti-fall and anti-impact protection.

The design in the embodiment mainly takes into the requirement of protecting sensitive elements in the mobile phone 120, especially the NFC antenna 400 and the ink screen 200; the NFC antenna 400 is used as a key part of communication; after the area of the NFC antenna 400 is increased, the NFC antenna 400 is more easily influenced by vibration generated during falling, and in order to reduce this influence, the wall thickness of the upper end and the lower end of the protective shell 100 is increased, so that a stronger physical protection can be provided when the mobile phone 120 falls; and a larger buffer area is formed through the thickened end wall, the impact force can be effectively absorbed, and thus the damage of vibration to the NFC antenna 400 is reduced; in addition, the ink screen 200 is a relatively fragile display technology, which is easily damaged in physical impact; the design of the protective shell 100 is also beneficial to protecting the ink screen 200, which can reduce the fault rate caused by falling or impact in daily use, and thus the service life of the device is prolonged; and moreover, the structure of the protective shell 100 also supports the function expansion of the NFC antenna 400, so that the area of the antenna can be increased without increasing the damage risk.

In an Embodiment 2 based on the above embodiments, the spacing between the edge, close to the side wall of the protective shell 100, of the installation groove 310 and the edge of the protective shell 100 is smaller than 5 mm, so that the projection overlapping area of the NFC antenna 400 and the NFC antenna 400 of the mobile phone 120 is increased.

According to the design of the embodiment, the available installation area of the NFC antenna 400 is expanded to the maximum extent; through the design, a large installation area is provided for the NFC antenna 400 in an existing protection shell 100 design framework under the condition that the area of the protection shell 100 is not increased, and the size of the protection shell 100 does not need to be increased, so that the space is saved, and the portability of the protection shell 100 is kept.

Optionally, the intelligent ink screen 200 mobile phone 120 shell further includes an NFC cover sheet 410; the NFC cover sheet 410 covers the NFC antenna 400; and when the NFC cover sheet 410 covers the NFC antenna 400, the NFC cover sheet 410 is flush with the upper surface of the installation plate 300.

According to the embodiment, the NFC cover sheet 410 is additionally designed for the NFC antenna 400, the NFC cover sheet 410 is designed to be consistent with the NFC antenna 400 in shape, and when the NFC cover sheet 410 covers the NFC antenna 400, the NFC cover sheet 410 is flush with the upper surface of the installation plate 300; the NFC cover sheet 410 is attached to the NFC antenna 400 in a gap-free covering mode; the NFC antenna 400 is stably installed in a groove body through the design of the NFC cover sheet 410, and thus the problem that the NFC antenna 400 is loosened or displaced in the using process is avoided; and in addition, a buffer protection layer is formed through the design, thus external pressure can be effectively absorbed and dispersed, and the damage to the NFC antenna 400 is avoided.

In one embodiment, anti-fall bumps are arranged at top corners of the protective shell 100.

Anti-fall bumps are arranged at four corners of the frame body 600, so that impact force from all angles can be dispersed and absorbed; when the mobile phone 120 falls off from a high place carelessly, the anti-fall bumps can effectively transfer and disperse the impact force, so that the impact force directly acting on the plane and internal components of the mobile phone 120 is reduced; and due to the design, sensitive elements, such as an internal chip of the mobile phone 120, the ink screen 200 and the NFC antenna 400, in the mobile phone 120 and the protective shell 100 can be protected, so that the possibility of damage is reduced.

In addition, ribs 150 are further arranged on an inner wall of the protective shell 100 in the embodiment, and the damage to the mobile phone 120 during falling can be reduced through the design; the protective shell 100 includes the frame body 600 and a back plate 700; two ribs 150 are arranged on the inner walls of the upper end and the lower end of the frame body 600 respectively, and the overall strength of the protective shell 100 can be enhanced through the design; and due to this arrangement, when the mobile phone 120 is impacted, the impact force can be absorbed and dispersed, so that the damage to the internal components of the mobile phone 120 can be reduced.

In one embodiment, a buffer member 320 is arranged in the installation groove 310.

In order to reduce the stress generated by the falling of the protective shell 100 on the ink screen 200, the buffer member 320 is arranged in the installation groove 310 and between the back plate 700 and the ink screen 200, in which, the buffer member 320 is foam, the foam can be high-elasticity ROPON foam, and the front side and the rear side of the foam can be adhered and fixed to a bottom surface of the installation groove 310 and the ink screen 200 through adhesives respectively.

In one embodiment, damping bumps are arranged at the edges of the protective shell 100.

A plurality of damping bumps are also arranged at the edges of the protective shell 100; the designed damping bumps can form an additional protective layer at the edges of the mobile phone 120; on one hand, when the mobile phone 120 falls off accidentally, the damping bumps can be in contact with the ground firstly to disperse the impact force, thus the force directly transmitted to the edge of the mobile phone 120 is reduced, and the risk of damage to the mobile phone 120 is reduced; the damping bumps can enhance the structural strength of the edges of the protective shell 100, thus the protection shell 100 can better bear the impact during falling, and reduce cracks or damage caused by falling; on the other hand, the damping bumps can increase the friction force between the hand and the protective shell 100, so that a better holding feeling is provided, a user can feel more stable when holding the mobile phone 120, and the possibility of slipping of the mobile phone 120 is reduced; the damping bumps increase the friction force, so the risk of slipping of the mobile phone 120 can be reduced even under the condition that the hand is wet or sweaty, and the safety of using the mobile phone 120 is improved; and the damping bumps can be made of silica gel or rubber and the like.

A lens frame 900 is arranged on the back surface of the protective shell 100, and a bracket 910 is hinged to the lens frame 900; and
when the protective shell 100 is horizontally placed, the bracket 910 is unfolded to support the mobile phone 120.

According to the intelligent ink screen 200 mobile phone 120 shell in the embodiment, the camera part is integrally formed at the upper end of the frame body 600, and the camera part extends from the frame body 600 to a direction away from the installation plate 300; the ribs are arranged at the back surface of the protective shell 100 close to the edge and wrap two sides of the lens frame 900 close to the edge, thus achieving the purpose of protecting the camera; in order to release the hands of the user, the mobile phone 120 installed in the protective shell 100 is supported on the plane, the lens frame 900 is arranged on the back surface of the protective shell 100, and the bracket 910 is arranged on the lens frame 900, has the same shape as the lens frame 900 and is hinged with the lens frame 900; when the bracket 910 is hinged with the protective shell 100 to form an included angle, the bracket 910 is used for supporting the mobile phone 120 located in the protective shell 100, and optionally, the bracket 910 can be hinged on the lens frame 900 through a damping shaft; and furthermore, a groove for accommodating the bracket 910 and having the same shape as the bracket 910 is formed in the lens frame 900, and the bracket 910 is made of metal.

In addition, in the embodiment, in order to realize the basic functions of the mobile phone 120 shell and facilitate the user to operate the mobile phone 120 located in the protective shell 100, the protective shell 100 is provided with a loudspeaker hole 670, a camera hole 710, an on-off key hole, a volume key hole 650 and a charging hole 680; and when the mobile phone 120 is assembled in the accommodating groove 110, the loudspeaker hole 670, the camera hole 710, the on-off key hole, the volume key hole 650 and the charging hole 680 are in one-to-one correspondence with a loudspeaker, a camera, an on-off key, a volume key and a charging socket on the mobile phone 120 respectively. Optionally, the protective shell 100 is further provided with a rope hole 660.

Optionally, in order to limit the NFC antenna 400 in the accommodating groove 110, the bottom surface of the accommodating groove 110 of the protective shell 100 is covered with a mylar 630, and the NFC antenna 400 is located between the mylar 630 and the back plate 700. The mylar piece 630 can be a PC mylar 630.

The working principle of the present invention is roughly as follows: when in use, a hanging rope is firstly penetrated through the rope hole, then the protective shell 100 sleeves the mobile phone 120, the camera, the volume key, the on-off key, the charging socket and the loudspeaker of the mobile phone 120 are clamped with the camera hole 710, the volume key hole 650, the on-off key hole, the charging hole 680 and the loudspeaker hole 670 on the protective shell 100 in the one-to-one correspondence way; after correct installation, the NFC antenna 400 on the protective shell 100 corresponds to the NFC antenna 400 of the mobile phone 120, so that the ink screen 200 on the protective shell 100 takes power from the mobile phone 120 through the NFC antenna 400 and the NFC antenna 400 of the mobile phone 120; the ink screen 200 and the NFC antenna 400 are connected through the connecting component 500, so that the picture conversion of the screen of the ink screen 200 is realized; during the next power taking, the ink screen 200 can always keep picture display; when a product needs to be replaced and maintained, the NFC antenna 400 can be separated from the ink screen 200 through the connecting component 500, corresponding parts are replaced, and different antennas and the same transmission mechanism can be used for mobile phone cases of different models, so that the assembly efficiency is improved, and the assembly cost is reduced.

As described above, the above embodiments are only used for illustrating the technical solution of the present invention, and not to limit it; although the present invention is described in detail with reference to the foregoing embodiments, those of ordinary skill in the art should understand that it may still be able to modify the technical solutions recorded in the foregoing embodiments, or equivalently replace some of the technical features therein; and these modifications or replacement do not make the essence of the corresponding technical solutions detached from the spirit and scope of the technical solutions of each embodiment of the present invention.

1. An NFC-based intelligent ink screen mobile phone case, comprising a protective shell, wherein an accommodating groove for accommodating a mobile phone is formed in the protective shell; the NFC-based intelligent ink screen mobile phone case further comprises an NFC antenna and an ink screen which are arranged on a back surface of the protective shell;
a connecting component is arranged between the ink screen and the NFC antenna; and the connecting component is used for electrically connecting the NFC antenna to the ink screen or separating the NFC antenna from the ink screen.

2. The NFC-based intelligent ink screen mobile phone case according to claim 1, further comprising an installation plate arranged on the back surface of the protective shell, wherein an installation groove for installing the NFC antenna and the ink screen is formed in a top portion of the installation plate; and an edge of the NFC antenna is tightly adjacent to an edge of the protective shell to increase a projection overlapping area of the NFC antenna and an NFC antenna of the mobile phone.

3. The NFC-based intelligent ink screen mobile phone case according to claim 2, wherein an upper edge of the installation groove extends towards an upper end frame of the protective shell until the height of the upper edge of the installation groove is above an inner wall of an upper end of the protective shell, so as to increase the projection overlapping area of the NFC antenna and the NFC antenna of the mobile phone.

4. The NFC-based intelligent ink screen mobile phone case according to claim 2, wherein a spacing between an edge, close to a side wall of the protective shell, of the installation groove and the edge of the protective shell is less than 5 mm so that the projection overlapping area of the NFC antenna and the NFC antenna of the mobile phone is increased.

5. The NFC-based intelligent ink screen mobile phone case according to claim 2, further comprising an NFC cover sheet, wherein the NFC cover sheet covers the NFC antenna; and when the NFC cover sheet covers the NFC antenna, the NFC cover sheet is flush with an upper surface of the installation plate.

6. The NFC-based intelligent ink screen mobile phone case according to claim 1, wherein the cross section of at least one of an upper end and a lower end of the protective shell is greater than the cross sections of a left side and a right side of the protective shell.

7. The NFC-based intelligent ink screen mobile phone case according to claim 6, wherein anti-fall bumps are arranged at top corners of the protective shell.

8. The NFC-based intelligent ink screen mobile phone case according to claim 2, wherein a buffer member is arranged in the installation groove.

9. The NFC-based intelligent ink screen mobile phone case according to claim 2, wherein damping bumps are arranged at the edges of the protective shell.

10. The NFC-based intelligent ink screen mobile phone case according to claim 1, wherein a lens frame is arranged on the back surface of the protective shell; the lens frame is hinged with a bracket; and
when the protective shell is horizontally placed, the bracket is unfolded to support the mobile phone case.
